(19) United States
(12) Patent Application Publication
(10) Pub. No.: US 2022/0089372 A1
(43) Pub. Date: Mar. 24, 2022

(54) SYSTEMS AND METHODS FOR MANAGING MOVEMENT OF MATERIALS HANDLING VEHICLES

(71) Applicant: Crown Equipment Corporation, New Bremen, OH (US)

(72) Inventors: Sian Phillips, Auckland (NZ); Samuel McArdle, Auckland (NZ)

(73) Assignee: Crown Equipment Corporation, New Bremen, OH (US)

(21) Appl. No.: 17/541,451

(22) Filed: Dec. 3, 2021

Related U.S. Application Data
(60) Provisional application No. 62/121,388, filed on Feb. 26, 2015.

(51) Int. Cl. B65G 1/137; B66F 9/06; G05D 1/02

(52) U.S. Cl. CPC B65G 1/1373; B66F 9/063; G05D 2201/0216; G05D 1/0289; G05D 1/0291; G05D 1/0214

(57) ABSTRACT

According to the subject matter of the present disclosure, an automated warehouse environment is provided where designated materials handling vehicles are programmed to initiate permission inquiries at primary and secondary nodes of a travel route in the warehouse environment. Alternatively, or additionally, the present disclosure also presents an automated warehouse environment where an asset manager comprises an occupancy grid generator, and a designated materials handling vehicle is programmed to avoid otherwise unpermitted travel along path segments that overlap the locked cells of the occupancy grid.

### CROSS-REFERENCE TO RELATED APPLICATIONS

This application claims the benefit of U.S. Provisional Application Ser. No. 62/121,388 (CRNZ 2032 MA), filed Dec. 4, 2020.

### BACKGROUND

The present specification generally relates to systems and methods for managing the movement of materials handling vehicles in a warehouse environment and, more specifically, to systems and methods for enabling materials handling vehicles to travel along specified routes in a warehouse environment in an efficient manner.

Materials handling vehicles including, for example, tuggers, forklift trucks, hand and motor driven pallet trucks, and other materials handling vehicles are used to move materials in a variety of environments. These vehicles can be configured as partially or fully automated guided vehicles that navigate through the environment, and are typically equipped with motion sensors, proximity sensors, or other types of sensing systems, to enable localization and navigation, while avoiding collisions with other vehicles within the environment. In many cases, partially or fully automated materials handling vehicles are configured to travel along a route, while maintaining communications with a navigation control server and/or other vehicles, to avoid collisions with vehicles, personnel, or other obstacles within the environment.

### BRIEF SUMMARY

The present inventors have recognized that active navigation, localization, and collision avoidance systems for materials handling vehicles often require a significant amount of sensing hardware and computing capacity on the vehicle itself. This requirement increases vehicle cost and operational burdens. More specifically, the present inventors have recognized that existing solutions for localization, navigation, and collision avoidance may excessively burden the computational resources of the vehicle and cause excess positioning or navigational delays as the vehicle moves through the operating environment, particularly where operation relies on the sensing components of a vehicle to avoid collisions. Accordingly, the present inventors have recognized that a need exists for a system that facilitates efficient fully or partially automated movement of materials handling vehicles within an industrial environment without excessively burdening the components of these vehicles.

According to the subject matter of the present disclosure, an automated warehouse environment is provided where designated materials handling vehicles are programmed to initiate permission inquiries at primary and secondary nodes of a travel route in the warehouse environment. Alternatively, or additionally, the present disclosure also presents an automated warehouse environment where an asset manager comprises an occupancy grid generator, and a designated materials handling vehicle is programmed to avoid otherwise unpermitted travel along path segments that overlap the locked cells of the occupancy grid.

In accordance with one embodiment of the present disclosure, an automated warehouse environment is provided comprising a plurality of materials handling zones, a plurality of materials handling vehicles, and an asset manager in communication with the materials handling vehicles. The asset manager and the materials handling vehicles collectively comprise a dynamic localization engine that is programmed to establish location data of the materials handling vehicles in the warehouse environment, as the vehicles move throughout the warehouse environment. The asset manager further comprises a path planner that is programmed to establish a travel route for a designated vehicle along established path segments in the warehouse environment, the travel route comprising primary nodes and secondary nodes. At least one primary node of the plurality of primary nodes established by the asset manager is correlated with a materials handling zone or a dedicated vehicular zone of the warehouse environment. The secondary nodes of the travel route established by the asset manager are correlated with established path segments in the warehouse environment. The path planner is further programmed to establish the travel route through the warehouse environment by, at least, establishing one primary node as an origin node and another primary node as a destination node, and referring to location data representing the locations of the origin node, the destination node, and the designated materials handling vehicle. The designated materials handling vehicle is programmed to proceed from the origin node to the destination node along the established path segments by, at least, initiating permission inquiries at a primary node and a secondary node of the travel route before proceeding from one path segment of the travel route to a successive path segment of the travel route, the permission inquiries referring to location data of the other materials handling vehicles in the warehouse environment.

In accordance with another embodiment of the present disclosure, an automated warehouse environment is provided where the primary nodes established by the asset manager are not necessarily correlated with a materials handling zone or a dedicated vehicular zone of the warehouse environment.

In accordance with a further embodiment of the present disclosure, an automated warehouse environment is provided where the travel route established by the asset manager does not include secondary nodes.

In accordance with a further embodiment of the present disclosure, an automated warehouse environment is provided comprising a plurality of materials handling zones, a plurality of materials handling vehicles, and an asset manager in communication with the materials handling vehicles. The asset manager and the materials handling vehicles collectively comprise a dynamic localization engine, a path planner, and an occupancy grid generator that is programmed to establish a dynamic occupancy grid corresponding to the warehouse environment and to lock cells of the occupancy grid in an established path segment that lead the designated materials handling vehicle as it travels in the established path segment. The designated materials handling vehicle is programmed to proceed from an origin node to a destination node along the established path segments by, at least, referring to data representing locked cells of the occupancy grid and avoiding otherwise unpermitted travel along path segments that overlap the locked cells of the occupancy grid.

In accordance with a further embodiment of the present disclosure, an asset manager is provided, and is configured to communicate with a plurality of materials handling vehicles in a warehouse environment. The asset manager comprises a dynamic localization engine and a path planner and is programmed to respond to permission inquiries from designated materials handling vehicles proceeding from origin nodes to destination nodes along established path segments. The permission inquiries can be initiated at primary and secondary nodes of the travel routes, and may refer to location data of the other materials handling vehicles in the warehouse environment.

In accordance with a further embodiment of the present disclosure, an asset manager is provided comprising an occupancy grid generator that is programmed to establish a dynamic occupancy grid corresponding to the warehouse environment and to lock cells of the occupancy grid in an established path segment that lead the designated materials handling vehicle as it travels in the established path segment.

According to a first aspect of any of the above-noted embodiments, the permission inquiries return a negative result, prohibiting travel in the successive path segment, when another materials handling vehicle occupies the successive path segment and a positive result, permitting travel in the successive path segment, when another materials handling vehicle does not occupy the successive path segment.

According to another aspect of any of the above-noted embodiments, or further in combination with one or more of the previously mentioned aspects of the above-noted embodiments, the designated materials handling vehicle is programmed to initiate permission inquiries at a plurality of secondary nodes along the travel route.

According to another aspect of any of the above-noted embodiments, or further in combination with one or more of the previously mentioned aspects of the above-noted embodiments, a plurality of the primary nodes of the travel route are correlated with materials handling zones, materials handling zone entries, materials handling zone exits, or combinations thereof.

According to another aspect of any of the above-noted embodiments, or further in combination with one or more of the previously mentioned aspects of the above-noted embodiments, the primary nodes of the travel route are correlated with materials handling zones comprising a receiving staging area, a shipping staging area, a warehouse rack storage aisle, or combinations thereof.

According to another aspect of any of the above-noted embodiments, or further in combination with one or more of the previously mentioned aspects of the above-noted embodiments, the automated warehouse environment further comprises dedicated vehicular zones that are physically displaced from the materials handling zones, and the travel route comprises additional primary nodes that are correlated with the dedicated vehicular zones.

According to another aspect of any of the above-noted embodiments, or further in combination with one or more of the previously mentioned aspects of the above-noted embodiments, the primary nodes of the travel route, the secondary nodes of the travel route, or a secondary node and a primary node of the travel route, delineate end points of established path segments in the warehouse environment.

According to another aspect of any of the above-noted embodiments, or further in combination with one or more of the previously mentioned aspects of the above-noted embodiments, the asset manager further comprises an occupancy grid generator that is programmed to establish a dynamic occupancy grid corresponding to the warehouse environment and to lock cells of the occupancy grid in an established path segment that lead the designated materials handling vehicle as it travels in the established path segment such that additional designated materials handling vehicles traveling within the warehouse environment are prohibited from traveling along path segments that overlap the locked cells of the occupancy grid.

According to another aspect of any of the above-noted embodiments, or further in combination with one or more of the previously mentioned aspects of the above-noted embodiments, each materials vehicle is configured to generate its own localization data using an on-board or off-board sensor-and-algorithm system.

According to another aspect of any of the above-noted embodiments, or further in combination with one or more of the previously mentioned aspects of the above-noted embodiments, the dynamic localization engine establishes location data of the materials handling vehicles in the warehouse environment using vehicle-based localization systems, asset manager-based localization systems, or combinations thereof.

According to another aspect of any of the above-noted embodiments, or further in combination with one or more of the previously mentioned aspects of the above-noted embodiments, the path planner is programmed to establish travel routes for a plurality of additional designated vehicles traveling simultaneously in the warehouse environment, and each of the plurality of travel routes comprise primary nodes, secondary nodes, and intersecting or common path segments.

According to another aspect of any of the above-noted embodiments, or further in combination with one or more of the previously mentioned aspects of the above-noted embodiments, the path planner is programmed to establish the travel route through the warehouse environment by further referring to location data representing physical objects in the warehouse environment.

According to another aspect of any of the above-noted embodiments, or further in combination with one or more of the previously mentioned aspects of the above-noted embodiments, the materials handling zones are equipped for the placement, storage, and retrieval of articles.

According to another aspect of any of the above-noted embodiments, or further in combination with one or more of the previously mentioned aspects of the above-noted embodiments, the asset manager further comprises a request converter that is programmed to cooperate with the path planner to convert a task request to a travel route for a designated vehicle.

According to another aspect of any of the above-noted embodiments, or further in combination with one or more of the previously mentioned aspects of the above-noted embodiments, the permission inquiries return a negative result, prohibiting travel in the successive path segment, when another materials handling vehicle occupies the successive path segment and a positive result, permitting travel in the successive path segment, when another materials handling vehicle does not occupy the successive path segment, the primary nodes of the travel route are correlated with a materials handling zone entry, a materials handling zone exit, or both, the automated warehouse environment further comprises dedicated vehicular zones that are physically displaced from the materials handling zones, and the travel route comprises additional primary nodes that are correlated with the dedicated vehicular zones, and the secondary nodes of the travel route, or a secondary node and a primary node of the travel route, delineate end points of established path segments in the warehouse environment.

According to another aspect of any of the above-noted embodiments, or further in combination with one or more of the previously mentioned aspects of the above-noted embodiments, the permission inquiries return a negative result, prohibiting travel in the successive path segment, when another materials handling vehicle occupies the successive path segment and a positive result, permitting travel in the successive path segment, when another materials handling vehicle does not occupy the successive path segment, the secondary nodes of the travel route, or a secondary node and a primary node of the travel route, delineate end points of established path segments in the warehouse environment, and the asset manager further comprises an occupancy grid generator that is programmed to establish a dynamic occupancy grid corresponding to the warehouse environment and to lock cells of the occupancy grid in an established path segment that lead the designated materials handling vehicle as it travels in the established path segment such that additional designated materials handling vehicles traveling within the warehouse environment are prohibited from traveling along path segments that overlap the locked cells of the occupancy grid.

For the purposes of defining and describing the concepts and scope of the present disclosure, it is noted that a “warehouse” encompasses any indoor or outdoor industrial facility in which materials handling vehicles transport goods including, but not limited to, indoor or outdoor industrial facilities that are intended primarily for the storage of goods, such as those where multi-level racks are arranged in aisles, and manufacturing facilities where goods are transported about the facility by materials handling vehicles for use in one or more manufacturing processes.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 is a schematic illustration of components of an automated warehouse environment according to embodiments of the present disclosure;

FIG. 2 is a virtual warehouse roadmap comprising a plurality of materials handling zones and a travel route comprising primary nodes and secondary nodes, according to embodiments of the present disclosure;

FIGS. 3-5 are virtual warehouse roadmaps comprising alternative travel routes according to embodiments of the present disclosure; and

FIGS. 6-8 illustrate the implementation of a warehouse occupancy grid according to embodiments of the present disclosure.

### DETAILED DESCRIPTION

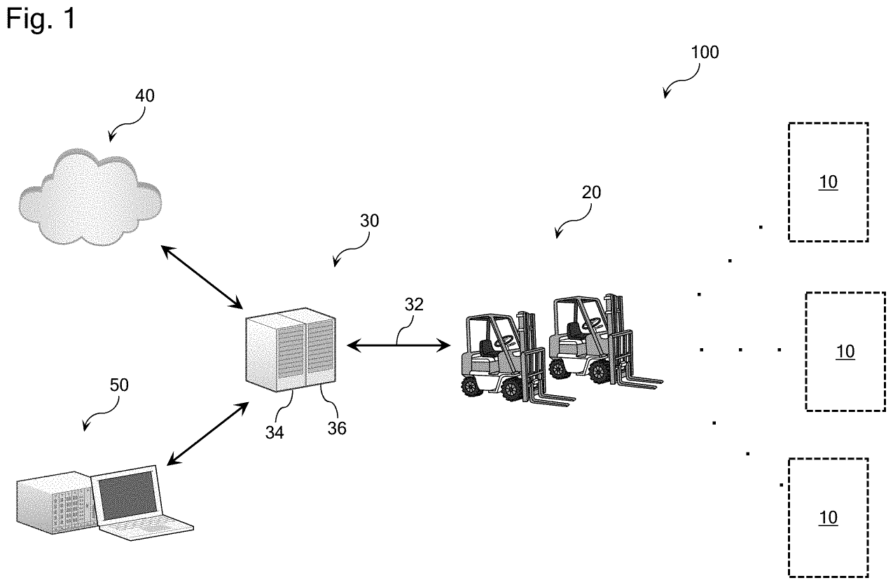

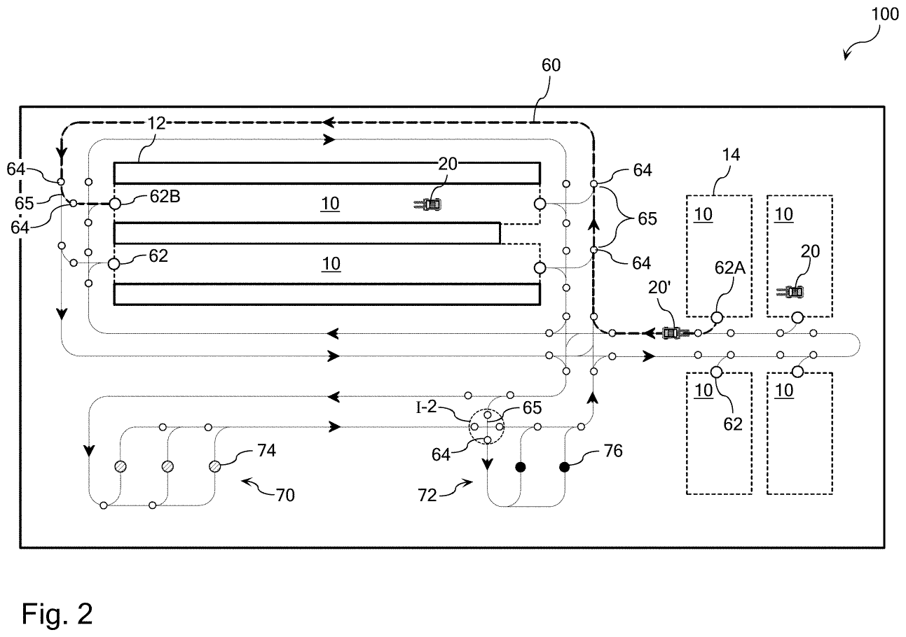

Referring initially to FIGS. 1 and 2, an automated warehouse environment 100 is provided comprising a plurality of materials handling zones 10, a plurality of materials handling vehicles 20, and an asset manager 30 in communication with the materials handling vehicles 20. The materials handling zones 10 are equipped for the placement, storage, and retrieval of articles and are most commonly the aisles formed between warehouse racks 12 and shipping/receiving staging areas 14 that are displaced from the warehouse aisles to facilitate shipping and receiving functions, as is illustrated schematically in FIG. 2, but may take a variety of forms, both conventional, and yet-to-be developed.

The automated warehouse environment 100 may also comprise one or more external delegates in the form of, for example, a cloud-based commissioning platform 40 and/or a local commissioning platform 50, both of which would be in communication with the asset manager 30. Contemplated commissioning platforms can take a variety of forms including, for example, mobile I/O devices, automation appliances, warehouse management systems (WMS), warehouse control systems (WCS), or similar devices for generating task requests dictating particular materials handling operations in the warehouse environment. To this end, the asset manager 30 may further comprise a request converter that would be programmed to cooperate with the path planner 34 to convert a task request to a travel route for a designated vehicle. Although the present disclosure is not limited to specific types of materials handling task requests, for illustrative purposes, it is noted that a task request may comprise, for example, a pallet move, a vehicle move, or other similar operations. The request converter can be programmed to receive the task request from the external delegates 40, 50 or from a materials handling vehicle in the warehouse environment 100.

The asset manager 30 and the materials handling vehicles 20 collectively comprise a dynamic localization engine 32 that is programmed to establish location data of the materials handling vehicles 20 in the warehouse environment 100, as the vehicles 20 move throughout the warehouse environment 100. In particular embodiments, the dynamic localization engine 32 establishes location data of the materials handling vehicles in the warehouse environment using vehicle-based localization systems, asset manager-based localization systems, or combinations thereof, as will be appreciated by those skilled in the art of materials handling vehicle localization and automation. For example, it is contemplated that the asset manager 30 and the materials handling vehicles 20 may share a map of the warehouse environment 100 to facilitate localization. Localization data and the path segments, primary nodes, secondary nodes, and occupancy grid described in detail below would all be established relative to this common map.

To further facilitate localization, each materials vehicle 20 can be configured to generate its own localization data using an on-board or off-board sensor-and-algorithm system, the details of which are outside of the scope of the present disclosure. Each materials handling vehicle 20, so configured, can use its localization data to establish its position on its current path segment, its distance travelled along the segment, and, hence, its proximity to the next segment. As the materials handling vehicle 20 approaches the next segment in its route, the vehicle 20 requests access to the next path segment. The asset manager 30 can then use an ID associated with the requested path segment to identify cells in an occupancy grid which need to be locked, and locks those cells, as needed. The asset manager 30 can be programmed to use the localization data that is periodically provided by the materials handling vehicles 20 to unlock cells on an occupancy grid as the vehicle 20 travels a granted path segment.

The asset manager 30 further comprises a path planner 34 that is programmed to establish a travel route 60, an example of which is illustrated in FIG. 2, for a plurality of designated vehicles 20′ for simultaneous travel along established path segments 65 in the warehouse environment 100. The travel route 60 comprises primary nodes 62 and secondary nodes 64 delineating the path segments 65. With multiple designated materials handling vehicles 20′ operating in the warehouse environment 100, each of the plurality of travel routes generated for the vehicles will comprise primary nodes, secondary nodes, and intersecting or common path segments, and different travel routes may share one or more primary nodes and one or more secondary nodes.

More specifically, one or more of the primary nodes 62 may be correlated with materials handling zones 10 of the warehouse environment 100 and are identified with relatively large open circles in FIG. 2, while the secondary nodes 64 are correlated with established path segments 65 in the warehouse environment 100, and are identified with relatively small open circles. Alternatively, it is contemplated that the primary nodes may be correlated with locations in the warehouse environment 100 that are not designated materials handling zones 10. For example, it is contemplated that the primary nodes may be correlated with any location in the warehouse environment 100 to which there is a need to guide a materials handling vehicle in a fully or partially autonomous mode. As is explained in further detail below, examples of such locations include parking stations, charging stations, etc.

In one embodiment, the path planner 34 can be further programmed to establish travel routes by referring to vehicle location data, i.e., location data representing the locations of other designated materials handling vehicles operating in the warehouse environment 100.

The primary nodes 62 of the travel route 60 may be correlated with the entry, exit, or other point of ingress or egress of the various materials handling zones 10 of the warehouse environment 100, or with any part of a materials handling zone 10 of the warehouse environment 100. For example, as is illustrated in FIG. 2, primary nodes 62 are correlated with the ends of the aisles that are formed between the illustrated warehouse racks 12, and with the points of ingress/egress of the set of four illustrated staging areas 14. Referring to the travel route 60 illustrated in FIG. 2, the designated materials handling vehicle 20′ is configured to pick up items from the staging area 14 and travel to the destination aisle of warehouse racks 12 to place the items in a designated bay in the warehouse racks 12. The asset manager 30 may transmit data defining the travel route 60 wirelessly to the designated materials handling vehicle 20′ as, for example, a digital file, either directly, or over a communications network. Upon receiving the route data, the designated materials handling vehicle 20′ processes the received route data and begins traveling along the route 60 at, for example, a predefined speed.

The end points of established path segments 65 in the warehouse environment may be delineated by secondary nodes 64 along the travel route 60, or by a secondary node 64 and a primary node 62 of the travel route 60. For example, referring to the 2-way intersection I-2 of FIG. 2, the secondary nodes 64 of the intersection I-2 are positioned such that the path segments 65 established between the nodes 64 forms the bounds of the vehicular intersection zone I-2. In which case, one of the delineated end points of the segment 65 will begin the vehicular intersection zone along one direction, and the other of the delineated end points of the segment will conclude the vehicular intersection zone I-2 along the same direction. In many cases, an established path segment will comprise a free travel zone, with one of the delineated end points of the segment beginning the free travel zone, and the other of the delineated end points of the segment concluding the free travel zone.

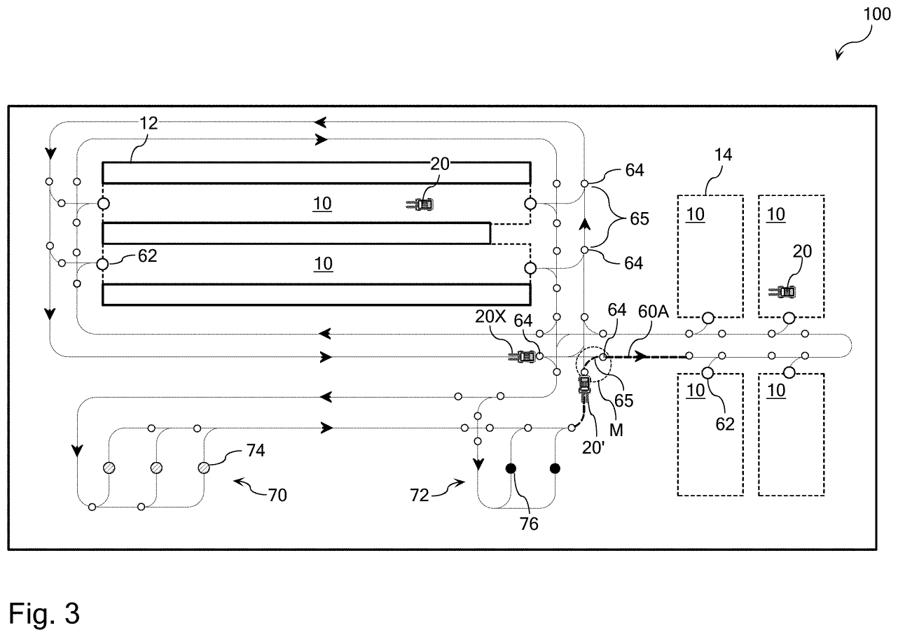

Referring to FIG. 3, an established path segment 65 of an alternative travel route 60A for a designated materials handling vehicle 20′ may comprises a vehicular merge zone M. In which case, one of the delineated end points of the segment 65 in the merge zone M will delineate the beginning of the vehicular merge zone M, and the other of the delineated end points of the segment 65 will conclude the vehicular merge zone M. FIG. 3 also illustrates the manner in which the asset manager 30 may be programmed to manage the movement of the designated materials handling vehicle 20′ and a competing materials handling vehicle 20X approaching an interfering path segment 65. In the illustrated example, the competing materials handling vehicle 20X will be required to stop at the secondary node 64 at the beginning of the path segment that precedes the interfering path segment 65 and wait for the asset manager to grant the competing vehicle 20X permission to proceed in the direction of the interfering path segment 65. The asset manager may, for example, grant permission once the designated materials handling vehicle 20′ has traveled past the secondary node 64 at the conclusion of the interfering path segment 65.

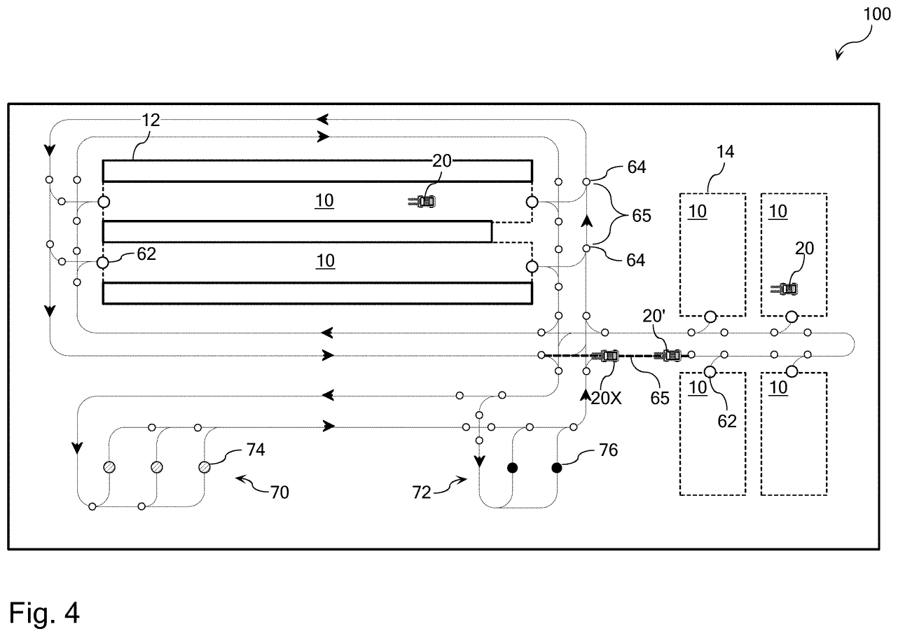

It is contemplated that the asset manager 30 may analyze various factors in determining whether to grant competing vehicles permission to travel on an interfering path segment. For example, the asset manager 30 may refer to conventional or yet-to-be developed traffic management rules. Alternatively, or additionally, the asset manager 30 may merely determine the distance between a designated materials handling vehicle 20′ that is currently utilizing a particular portion of a path segment 65 and a competing vehicle 20X that is requesting permission to travel on the path segment 65. If the distance between these vehicles is too small, indicating a likelihood of collision, the asset manager 30 will not permit the vehicles to travel on the same path segment 65. However, as is illustrated in FIG. 4, if the distance between the designated materials handling vehicle 20′ and the competing vehicle 20X is large enough to reduce the risk of collision to a low enough level, then asset manager 30 will permit the vehicles 20′, 20X to travel on the same path segment 65.

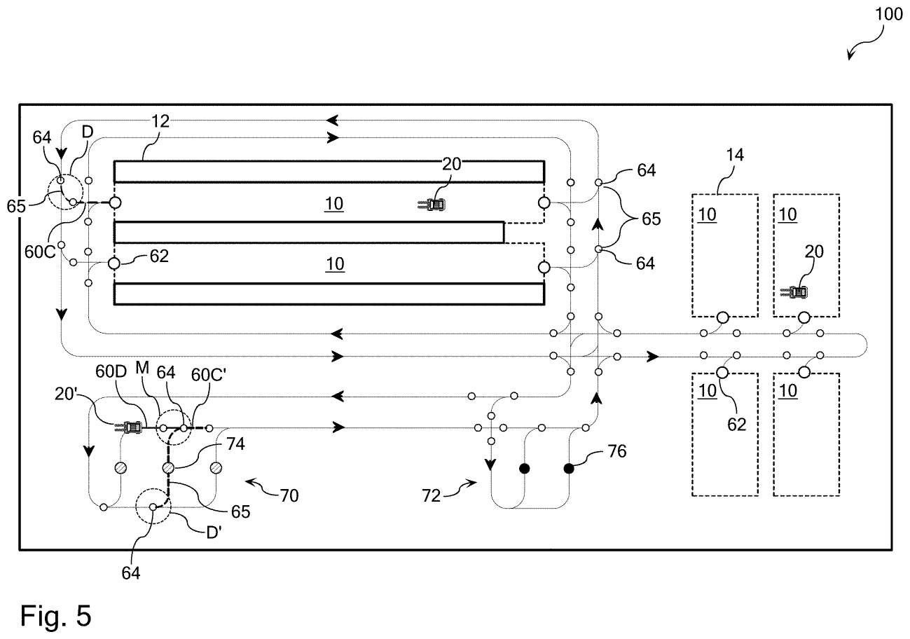

Referring to FIG. 5, an established path segment 65 of one or an alternative travel route 60C, 60C′ may comprise one or more vehicular diverge zones D, D′. In which case, one of the delineated end points of the path segment in the diverge zone D, D′ will mark the beginning of the vehicular diverge zone D, D′, and the other of the delineated end points of the segment 65 will conclude the vehicular diverge zone D, D′. Referring to the diverge zone D′, it is noted that the secondary nodes 64 at the end points of the path segment 65 may be arranged to encompass a primary node 74 of a dedicated vehicular zone 70, e.g., a vehicle charging station, or a vehicle parking station.

Referring further to alternate travel route 60D and merge zone M that are called out in FIG. 5, it is contemplated that a secondary node 64 may be positioned at a merging point of two path segments, while an additional secondary node 64 may be positioned to precede the merging point along the travel route 60D. In this manner, the asset manager 30 can be programmed to force a designated materials handling vehicle 20′ to stop at the secondary node preceding the merging point and request permission before proceeding. The asset manager 30 will grant or deny permission according to one or more of the considerations set forth above.

The automated warehouse environment 100 may further comprises dedicated vehicular zones 70, 72 that are physically displaced from the materials handling zones 10. These dedicated vehicular zones 70, 72 may comprise, for example, vehicle charging stations and vehicle parking stations, respectively, and may comprise additional primary nodes 74, 76 that can be used by the asset manager 30 for path planning and traffic management.

Referring further to FIG. 2, the path planner 34 of the asset manager 30 is further programmed to establish the travel route 60 through the warehouse environment 100 by establishing one primary node as an origin node 62A and another primary node as a destination node 62B. The path planner 34 of the asset manager 30 further refers to location data representing the locations of the origin node 62A, the destination node 62B, and the designated materials handling vehicle 20′ to determine the travel route 60. The path planner 34 may further refer to location data representing physical objects in the warehouse environment, e.g., i.e., storage racks, work stations, and other hardware in the warehouse environment to avoid collisions with the objects.

Location data regarding the designated materials handling vehicle 20′ may be sourced from the materials handling vehicle itself, as it moves through the warehouse environment 100. More specifically, the designated materials handling vehicle 20′, and other materials handling vehicles in the warehouse environment 100, may communicate intermediate location data at predefined time intervals, e.g., every 1 sec, 5 sec, 10 sec, etc., as the vehicle travels from an origin node 62A to a destination node 62B. In addition, the designated materials handling vehicle 20′, and other materials handling vehicles in the warehouse environment 100, may communicate intermediate location data when the vehicle reaches a secondary node 64.

Once the travel route 60 is determined, the designated materials handling vehicle 20′ is programmed to proceed from the origin node 62A to the destination node 62B along the established path segments 65 of the route 60 by initiating permission inquiries at the primary and secondary nodes 62, 64 of the travel route 60 before traveling along a path segment originating at a primary node 62, and before proceeding from one path segment 65 of the travel route to a successive path segment 65 of the travel route. More specifically, permission inquiries may be taken at the secondary nodes 64 along the travel route 60 and at the origin node 62A of the travel route before proceeding along a path segment extending from the origin node 62A to a secondary node 64.

The aforementioned permission inquiries may be taken “at” a primary or secondary node by initiating the inquiry before the materials handling vehicle physically reaches the node. By doing so, those practicing the concepts of the present disclosure can minimize vehicle stoppage time while the permission inquiry is being executed. Preferably, the inquiry would be initiated within a travel distance that is just close enough to permit completion of the permission inquiry, but not so far away from the node to introduce substantial risk that a competing materials handling vehicle could arrive at the path segment of interest before the designated vehicle.

It is also noted that the permission inquiries may specifically refer to location data of the other materials handling vehicles in the warehouse environment to inform the inquiry. Notably, when a permission inquiry taken at the start of the cleared path segment returns a positive result, the designated materials handling vehicle may be programmed to travel along a cleared path segment without the need for further permission inquiries. More specifically, regarding the permission inquiries that are taken at the primary and secondary nodes 62, 64 along the travel route 60, these inquiries will return a negative result, prohibiting travel in the successive path segment, when a competing materials handling vehicle already occupies the successive path segment along the route 60. At which point, the designated materials handling vehicle 20′ can be programmed to wait at the node 62, 64 for a certain period of time, e.g., until the competing materials handling vehicle completes traveling the entirety of the path segment at issue. Thereafter, the asset manager 30 may alter the status of the segment at issue as unoccupied and permit travel by the designated materials handling vehicle 20′. Alternatively, in some embodiments, the asset manager 30 may instruct the designated materials handling vehicle 20′ to wait at the node 62, 64 until the competing materials handling vehicle travels a certain distance along the segment at issue, e.g., a distance that is sufficient to reduce the likelihood of collision between the materials handling vehicles. In this way, the asset manager can be programmed to dynamically designate portions of a particular path segment 65 as unoccupied after a given materials handling vehicle completes traveling a certain distance along the path segment 65.

Conversely, the inquiries will return a positive result, permitting travel in the successive path segment, when another materials handling vehicle does not already occupy the successive path segment along the route 60. Exceptions to these two primary rules are contemplated. For example, it is contemplated that a permission inquiry may return an exception to a negative result, permitting travel in the successive path segment, when another materials handling vehicle occupies the successive path segment but is traveling away from the designated materials handling vehicle 20′ such that the designated materials handling vehicle 20′ may follow the other materials handing vehicle in the successive path segment without risk of collision. In another example, it is contemplated that a permission inquiry may return an exception to a positive, prohibiting travel in the successive path segment, when the inquiry is overridden by a traffic management rule that is designed to reduce the risk of collision. Alternatively, it is contemplated that a permission inquiry may return an exception to a negative result, permitting travel in the successive path segment, when the inquiry is overridden by a traffic management rule that is designed to increase traffic volume without unduly raising the risk of collision.

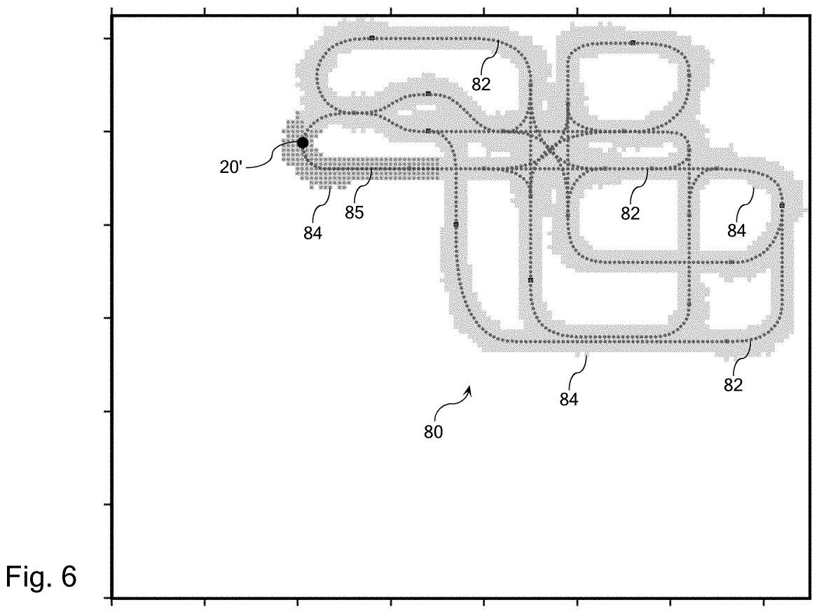

Referring to FIGS. 1 and 6-8, it is noted that the asset manager 30 may further comprise an occupancy grid generator 36 that is programmed to establish a dynamic occupancy grid 80 corresponding to a warehouse environment and the various potential materials handling vehicle travel paths 82 comprised therein. The occupancy grid 80 will comprise a plurality of cells 84, which may either be locked or unlocked, as is described in further detail below. Unlocked ones of the cells 84 are illustrated in FIGS. 6-8 as unfilled, shaded pixels, while locked ones of the cells 84 are illustrated as partially filled, shaded pixels.

The occupancy grid generator 36 can be programmed to lock selected groups of cells 84 of the occupancy grid 80 in an established path segment 85. More particularly, the occupancy grid generator 36 can be programmed to lock the cells 84 that lead the designated materials handling vehicle 20′ as it travels in the established path segment 85. In this manner, additional materials handling vehicles traveling within the warehouse environment along other path segments can be prohibited from traveling along path segments that overlap the locked cells leading the designated materials handling vehicle 20′ or other locked cells of the occupancy grid. These type of prohibitions can reduce the risk of collisions in the warehouse environment.

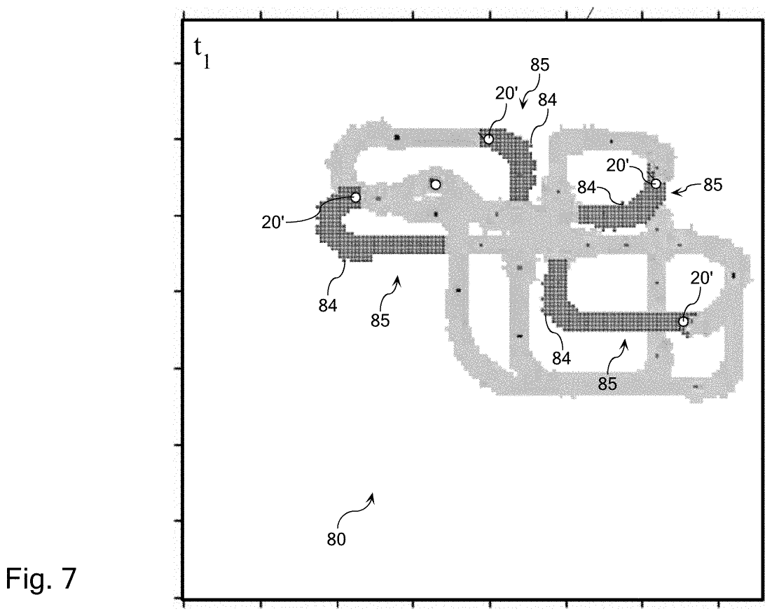

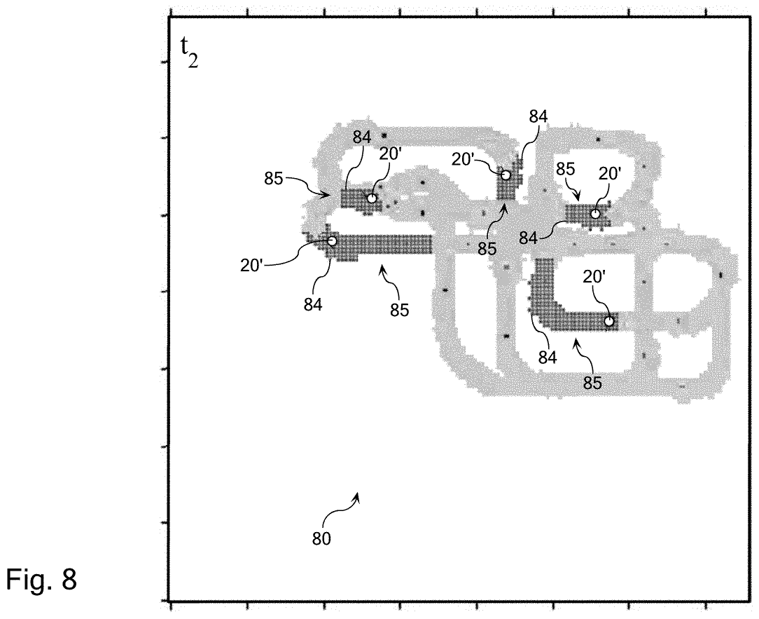

FIGS. 7 and 8 show multiple designated materials handling vehicles 20′ travelling along respective established path segments 85 in the occupancy grid 80 at an initial time t₁ (FIG. 7) and a subsequent time t₂ (FIG. 8). Notably, the cells 84 of the occupancy grid 80 are locked on a dynamic basis, such that only those cells extending from the designated materials handling vehicle 20′ to the secondary node terminating the established path segment 85 will be locked. In this manner, the locked portion of the established path segment 85 will diminish in size as the designated materials handling vehicle 20′ moves along a travel route comprising the established path segment 85, and then abruptly increase in size to occupy the entirety of a successive path segment upon entry into the successive path segment.

The asset manager 30 may be programmed to grant an additional designated materials handling vehicle traveling within the warehouse environment permission to travel along a path segment that overlaps the locked cells of the occupancy grid if conditions permit. For example, the asset manager 30 may be programmed to grant the additional designated materials handling vehicle permission to travel along path segments that overlap the locked cells of the occupancy grid by referring to a set of traffic management rules designed to optimize traffic volume while limiting the risk of collisions. More specifically, for example, the asset manager 30 can be programmed to grant two designated materials handling vehicles permission to travel, one following the other, along a common path segment comprising a common set of locked cells. To do so, the asset manager 30 may account for factors such as the distance along a path segment traveled by a materials handling vehicle, the likelihood of a collision between two materials handling vehicles, the length of the path segment, etc.

The occupancy grid generator 36 can be programmed to establish cells of the occupancy grid 80 by overlaying the established path segment 85 on the occupancy grid and sweeping a vehicle footprint along the path segment 85. The vehicle footprint may be, for example, a 2D shape that represents the physical space that the designated materials vehicle will require to travel along the designated path segment 85. The vehicle footprint will typically be larger than the physical size of the designated materials handling vehicle 20′ to account for vehicle clearance requirements. By establishing cells in spaces of the occupancy grid 80 corresponding to footprints of the materials handling vehicles traveling therein, collisions can be avoided in cases where, while two path segments may not actually overlap or intersect, there is not enough physical space between the path segments for the two materials handling vehicles to pass at the same time. This approach also allows the asset manager 30 to lock cells based on the dimensions of the AGV requesting access. Accordingly, for example, there may be situations where two smaller vehicles would be permitted to pass each other along two closely spaced path segments, while travel for a larger vehicle would be blocked.

It is noted that recitations herein of a component of the present disclosure being “configured” or “programmed” in a particular way, to embody a particular property, or to function in a particular manner, are open-ended, structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. An automated warehouse environment comprising a plurality of materials handling zones, a plurality of materials handling vehicles, and an asset manager in communication with the materials handling vehicles, wherein:
the asset manager and the materials handling vehicles collectively comprise a dynamic localization engine that is programmed to establish location data of the materials handling vehicles in the warehouse environment, as the vehicles move throughout the warehouse environment;
the asset manager further comprises a path planner that is programmed to establish a travel route for a designated vehicle along established path segments in the warehouse environment, the travel route comprising primary nodes and secondary nodes;
at least one primary node of the plurality of primary nodes established by the asset manager is correlated with a materials handling zone or a dedicated vehicular zone of the warehouse environment;
the secondary nodes of the travel route established by the asset manager are correlated with established path segments in the warehouse environment;
the path planner is further programmed to establish the travel route through the warehouse environment by, at least, establishing one primary node as an origin node and another primary node as a destination node, and referring to location data representing the locations of the origin node, the destination node, and the designated materials handling vehicle; and
the designated materials handling vehicle is programmed to proceed from the origin node to the destination node along the established path segments by, at least, initiating permission inquiries at a primary node and a secondary node of the travel route before proceeding from one path segment of the travel route to a successive path segment of the travel route, the permission inquiries referring to location data of the other materials handling vehicles in the warehouse environment.

2. The automated warehouse environment as claimed in claim 1 wherein the permission inquiries return a negative result, prohibiting travel in the successive path segment, when another materials handling vehicle occupies the successive path segment and a positive result, permitting travel in the successive path segment, when another materials handling vehicle does not occupy the successive path segment.

3. The automated warehouse environment as claimed in claim 2 wherein the permission inquiries return an exception to a negative result, permitting travel in the successive path segment, when another materials handling vehicle occupies the successive path segment and is traveling away from the designated materials handling vehicle such that the designated materials handling vehicle will follow the other materials handing vehicle in the successive path segment.

4. The automated warehouse environment as claimed in claim 2 wherein the permission inquiries return an exception to a positive or negative result when overridden by a traffic management rule.

5. The automated warehouse environment as claimed in claim 2 wherein the designated materials handling vehicle is programmed to travel along a cleared path segment without the need for further permission inquiries when a permission inquiry returns a positive result.

6. The automated warehouse environment as claimed in claim 1 wherein the designated materials handling vehicle is programmed to initiate permission inquiries at a plurality of secondary nodes along the travel route.

7. The automated warehouse environment as claimed in claim 1 wherein a plurality of the primary nodes of the travel route are correlated with materials handling zones, materials handling zone entries, materials handling zone exits, or combinations thereof.

8. The automated warehouse environment as claimed in claim 1 wherein the primary nodes of the travel route are correlated with materials handling zones comprising a receiving staging area, a shipping staging area, a warehouse rack storage aisle, or combinations thereof.

9. The automated warehouse environment as claimed in claim 1 wherein
the automated warehouse environment further comprises dedicated vehicular zones that are physically displaced from the materials handling zones;
the travel route comprises additional primary nodes that are correlated with the dedicated vehicular zones.

10. The automated warehouse environment as claimed in claim 9 wherein the dedicated vehicular zones comprise vehicle charging stations, vehicle parking stations, or both.

11. The automated warehouse environment as claimed in claim 1 wherein the primary nodes of the travel route, the secondary nodes of the travel route, or a secondary node and a primary node of the travel route, delineate end points of established path segments in the warehouse environment.

12. The automated warehouse environment as claimed in claim 11 wherein the established path segment comprises a vehicular intersection zone, one of the delineated end points begins the vehicular intersection zone, and the other of the delineated end points concludes the vehicular intersection zone.

13. The automated warehouse environment as claimed in claim 11 wherein the established path segment comprises a vehicular merge zone, one of the delineated end points begins the vehicular merge zone, and the other of the delineated end points concludes the vehicular merge zone.

14. The automated warehouse environment as claimed in claim 11 wherein the established path segment comprises a vehicular diverge zone, one of the delineated end points begins the vehicular diverge zone, and the other of the delineated end points concludes the vehicular diverge zone.

15. The automated warehouse environment as claimed in claim 11 wherein the established path segment comprises a free travel zone, one of the delineated end points begins the free travel zone, and the other of the delineated end points concludes the free travel zone.

16. The automated warehouse environment as claimed in claim 1 wherein the asset manager further comprises an occupancy grid generator that is programmed to establish a dynamic occupancy grid corresponding to the warehouse environment and to lock cells of the occupancy grid in an established path segment that lead the designated materials handling vehicle as it travels in the established path segment such that additional designated materials handling vehicles traveling within the warehouse environment are prohibited from traveling along path segments that overlap the locked cells of the occupancy grid.

17. The automated warehouse environment as claimed in claim 16 wherein the locked cells extend from the designated materials handling vehicle to the secondary node terminating the established path segment such that a locked portion of the established path segment diminishes in size as the designated materials handling vehicle moves along the travel route in the established path segment.

18. The automated warehouse environment as claimed in claim 16 wherein the asset manager is programmed to grant an additional designated materials handling vehicle traveling within the warehouse environment permission to travel along a path segment that overlaps the locked cells of the occupancy grid.

19. The automated warehouse environment as claimed in claim 18 wherein the asset manager is programmed to grant the additional designated materials handling vehicle permission to travel along path segments that overlap the locked cells of the occupancy grid by referring to a set of traffic management rules.

20. The automated warehouse environment as claimed in claim 16 wherein the asset manager is programmed to grant two designated materials handling vehicles permission to travel, one following the other, along a common path segment comprising a common set of locked cells.

21. The automated warehouse environment as claimed in claim 16 wherein the occupancy grid generator is programmed to establish cells of the occupancy grid by, at least, overlaying the established path segment on the occupancy grid and sweeping a vehicle footprint along the path segment.

22. The automated warehouse environment as claimed in claim 1 wherein each materials vehicle is configured to generate its own localization data using an on-board or off-board sensor-and-algorithm system.

23. The automated warehouse environment as claimed in claim 1 wherein the dynamic localization engine establishes location data of the materials handling vehicles in the warehouse environment using vehicle-based localization systems, asset manager-based localization systems, or combinations thereof.

24. The automated warehouse environment as claimed in claim 1 wherein:
the path planner is programmed to establish travel routes for a plurality of additional designated vehicles traveling simultaneously in the warehouse environment; and
each of the plurality of travel routes comprise primary nodes, secondary nodes, and intersecting or common path segments.

25. The automated warehouse environment as claimed in claim 24 wherein the path planner is programmed to establish travel routes through the warehouse environment by further referring to location data representing the locations of the additional designated materials handling vehicles in the warehouse environment.

26. The automated warehouse environment as claimed in claim 1 wherein the path planner is programmed to establish the travel route through the warehouse environment by further referring to location data representing physical objects in the warehouse environment.

27. The automated warehouse environment as claimed in claim 1 wherein the materials handling zones are equipped for the placement, storage, and retrieval of articles.

28. The automated warehouse environment as claimed in claim 27 wherein the materials handling zones comprise storage racks arranged along warehouse aisles and staging areas displaced from the warehouse aisles to facilitate shipping and receiving functions.

29. The automated warehouse environment as claimed in claim 1 wherein the asset manager further comprises a request converter that is programmed to cooperate with the path planner to convert a task request to a travel route for a designated vehicle.

30. The automated warehouse environment as claimed in claim 29 wherein the automated warehouse environment further comprises an external delegate and the request converter is programmed to receive the task request from the external delegate or one of the plurality of materials handling vehicles.

31. The automated warehouse environment as claimed in claim 1 wherein:
the permission inquiries return a negative result, prohibiting travel in the successive path segment, when another materials handling vehicle occupies the successive path segment and a positive result, permitting travel in the successive path segment, when another materials handling vehicle does not occupy the successive path segment;
the primary nodes of the travel route are correlated with a materials handling zone entry, a materials handling zone exit, or both;
the automated warehouse environment further comprises dedicated vehicular zones that are physically displaced from the materials handling zones, and the travel route comprises additional primary nodes that are correlated with the dedicated vehicular zones; and
the secondary nodes of the travel route, or a secondary node and a primary node of the travel route, delineate end points of established path segments in the warehouse environment.

32. The automated warehouse environment as claimed in claim 31 wherein the asset manager further comprises an occupancy grid generator that is programmed to establish a dynamic occupancy grid corresponding to the warehouse environment and to lock cells of the occupancy grid in an established path segment that lead the designated materials handling vehicle as it travels in the established path segment such that additional designated materials handling vehicles traveling within the warehouse environment are prohibited from traveling along path segments that overlap the locked cells of the occupancy grid.

33. The automated warehouse environment as claimed in claim 1 wherein:
the permission inquiries return a negative result, prohibiting travel in the successive path segment, when another materials handling vehicle occupies the successive path segment and a positive result, permitting travel in the successive path segment, when another materials handling vehicle does not occupy the successive path segment;
the secondary nodes of the travel route, or a secondary node and a primary node of the travel route, delineate end points of established path segments in the warehouse environment; and
the asset manager further comprises an occupancy grid generator that is programmed to establish a dynamic occupancy grid corresponding to the warehouse environment and to lock cells of the occupancy grid in an established path segment that lead the designated materials handling vehicle as it travels in the established path segment such that additional designated materials handling vehicles traveling within the warehouse environment are prohibited from traveling along path segments that overlap the locked cells of the occupancy grid.

34. An automated warehouse environment comprising a plurality of materials handling zones, a plurality of materials handling vehicles, and an asset manager in communication with the materials handling vehicles, wherein:
the asset manager and the materials handling vehicles collectively comprise a dynamic localization engine that is programmed to establish location data of the materials handling vehicles in the warehouse environment, as the vehicles move throughout the warehouse environment;
the asset manager further comprises a path planner that is programmed to establish a travel route for a designated vehicle along established path segments in the warehouse environment, the travel route comprising primary nodes and secondary nodes;
at least one of the primary nodes of the travel route established by the asset manager is correlated with a materials handling zone or a dedicated vehicular zone of the warehouse environment;
the secondary nodes of the travel route established by the asset manager are correlated with established path segments in the warehouse environment;
the path planner is further programmed to establish the travel route through the warehouse environment by, at least, establishing one primary node as an origin node and another primary node as a destination node, and referring to location data representing the locations of the origin node, the destination node, and the designated materials handling vehicle;
the asset manager further comprises an occupancy grid generator that is programmed to establish a dynamic occupancy grid corresponding to the warehouse environment and to lock cells of the occupancy grid in an established path segment that lead the designated materials handling vehicle as it travels in the established path segment such that additional designated materials handling vehicles traveling within the warehouse environment are prohibited from traveling along path segments that overlap the locked cells of the occupancy grid; and
the designated materials handling vehicle is programmed to proceed from the origin node to the destination node along the established path segments by, at least, referring to data representing locked cells of the occupancy grid and avoiding otherwise unpermitted travel along path segments that overlap the locked cells of the occupancy grid.

35. An asset manager configured to communicate with a plurality of materials handling vehicles in a warehouse environment, the asset manager comprising:
a dynamic localization engine that is programmed to establish location data of the materials handling vehicles in the warehouse environment, as the vehicles move throughout the warehouse environment; and
a path planner that is programmed to establish travel routes for designated materials handling vehicles along established path segments in the warehouse environment, the travel routes comprising primary nodes and secondary nodes, wherein
at least one of the primary nodes of the travel routes established by the asset manager is correlated with a materials handling zone or a dedicated vehicular zone of the warehouse environment,
the secondary nodes of the travel routes established by the asset manager are correlated with established path segments in the warehouse environment,
the path planner is further programmed to establish the travel routes through the warehouse environment by, at least, establishing origin nodes and destination nodes, and referring to location data representing the locations of the origin nodes, the destination nodes, and the designated materials handling vehicles, and
the asset manager is programmed to respond to permission inquiries from designated materials handling vehicles proceeding from origin nodes to destination nodes along established path segments, the permission inquiries being initiated at primary and secondary nodes of the travel routes, and referring to location data of the other materials handling vehicles in the warehouse environment.

36. An asset manager configured to communicate with a plurality of materials handling vehicles in a warehouse environment, the asset manager comprising:
a dynamic localization engine that is programmed to establish location data of the materials handling vehicles in the warehouse environment, as the vehicles move throughout the warehouse environment;
a path planner that is programmed to establish a travel route for a designated vehicle along established path segments in the warehouse environment, the travel route comprising primary nodes and secondary nodes; and
an occupancy grid generator that is programmed to establish a dynamic occupancy grid corresponding to the warehouse environment, wherein
at least one of the primary nodes of the travel route established by the asset manager is correlated with a materials handling zone or a dedicated vehicular zone of the warehouse environment,
the secondary nodes of the travel route established by the asset manager are correlated with established path segments in the warehouse environment,
the path planner is further programmed to establish the travel routes through the warehouse environment by, at least, establishing origin nodes and destination nodes, and referring to location data representing the locations of the origin nodes, the destination nodes, and the designated materials handling vehicles, and
the occupancy grid generator is programmed to lock cells of the occupancy grid in an established path segment that lead the designated materials handling vehicle as it travels in the established path segment such that additional designated materials handling vehicles traveling within the warehouse environment are prohibited from traveling along path segments that overlap the locked cells of the occupancy grid.
